(19) United States
(12) Patent Application Publication
(10) Pub. No.: US 2009/0247678 A1
(43) Pub. Date: Oct. 1, 2009

(54) Cross-Linkable Polyolefin Composition Having the Tree Resistance

(75) Inventors: Seung Hyung Lee, Daejeon (KR); Han Shin Lee, Daejeon (KR); Jung Ho Kong, Daejeon (KR); Ki Sik Kim, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: HANWHA CHEMICAL CORPORATION, Seoul (KR)

(21) Appl. No.: 12/297,802

(22) PCT Filed: Apr. 20, 2007
(86) PCT No.: PCT/KR2007/001928

§ 371 Date: Mar. 4, 2009

(30) Foreign Application Priority Data
Apr. 25, 2006 (KR) 10-2006-0037199

(51) Int. Cl. C08K 5/101

(52) U.S. Cl. 524/287

(57) ABSTRACT

The present invention relates to a tree resistant, cross-linkable polyolefin resin composition for insulation capable of improving electric properties of an insulator of the high voltage power cable and thus improving a long-life stability of an underground distribution cable as having a more superior resistance to water tree deterioration caused by moisture, superior thermal-oxidative stability, superior scorch resistance when extruding as well as obtaining a proper cross-linking degree when cross-linking.

### TECHNICAL FIELD

The present invention relates to a tree resistant, cross-linkable polyolefin resin composition having superior electrical insulating property and thermal stability, and more particularly, to a tree resistant, cross-linkable polyolefin composition for an insulation of a high voltage power cable, which is capable of improving electric properties of an insulator of the high voltage power cable and thus improving a long-life stability of an underground distribution cable as having a more superior resistance to water tree deterioration caused by moisture, superior thermal-oxidative stability, superior scorch resistance when extruding as well as obtaining a proper cross-linking degree when cross-linking.

### BACKGROUND ART

In power cables installed in an environment of high humidity or moistness, a deterioration phenomenon of cable insulator occurred by combination of moisture and electric stress were found by Miyasita of Japan in later 1960s from a problem that life of power cables are shortened and were officially named as a deterioration due to water trees. After then, many studies for water tree deterioration and its mechanism have been made in order to solve the above problem. The water tree, which is named as it has a tree-like shape, is generally known to be a cause of a deterioration phenomenon due to moisture. The water tree occurs from a void, a defection part or a pollutant, consists of micropores and has a characteristic of growing in a direction of electric field. The water tree grows at a slow speed when it occurs in an inside of a cable insulator or an interface between the cable insulator and semiconducting layer, but finally the water tree leads to decrease in a pressure resisting strength of a cable insulator and thus shortens life of a cable.

Meanwhile, in the case of general underground distribution, a conductor is maintained generally at a temperature from 60° C. to 90° C. though the temperature may varies as voltage applied. In such the condition, problems in a thermal resistance and a long period thermal-oxidative stability are generated if using a polyolefin having a melting point of 100° C. to 120° C. as it is to a power cable. Polyethylene is therefore cross-linked in a net-shaped structure by a chemical cross-linking, a water cross-linking and an irradiation cross-linking in order to improve the thermal resistance of the high voltage power cable. In the above mentioned cross-linking methods, the chemical cross-linking causes a residual product such as organic peroxides, generated from pyrolysis of a chemical cross-linking agent, to form a radical as a cross-linking point to the polyethylene and finally become a cross-link of the polyethylene.

A trouble occurred whenever extruding XLPE, which is an insulating material formulated with a chemical cross-linking agent, is an occurrence of a so-called scorch phenomenon (occurrence of partial early cross-linking from insulator during extrusion) when insulating the cable and the scorch occurred during the extrusion acts as a factor that decreases an electric insulating property of the insulating material. It is therefore also important to avoid the occurrence of the scorch to extend the life of the power cable. In order to solve the above problem, an improvement in thermal-oxidative stability and scorch is conventionally obtained by increasing antioxidant and, in this case, an advantage by formulation of the increased antioxidant can be obtained whereas there is an adverse effect of a low cross-linking degree after cross-linking by formulation of the increased antioxidant.

In addition, various solutions have been reported in documents for restrict a water tree, which is a kind of a deterioration phenomenon and occurs in an inside of an insulator during use of a power cable, in order that a power cable have the longer life span by improving an electric insulation performance of the power cable. In example, U.S. Pat. No. 4,305,849 discloses use of polyethylene glycol for resisting water tree and use of 4,4′-thiobis(2-t-butyl-5-methylphenol) as an antioxidant. Furthermore, Korean Patent No. 0413016 and U.S. Pat. No. 6,869,995 also propose a method of defining and increasing formulating three kinds of antioxidants including polyethylene glycol for resisting water tree, 4,4′-thiobis(2-t-butyl-5-methylphenol) which is generally used in cross-linkable polyethylene for an insulation of power cables and so on. The method described in the Korean Patent No. 0413016 and the U.S. Pat. No. 6,869,995 proposes improvement in thermal stability and scorch resistance with increasing formulating amount of a certain antioxidant, however there is a disadvantage that a cross-linking degree is decreased when simply increasing formulating the antioxidant alone in a cross-link of a composition in relation to a performance of power cables. In other words, a cross-linking efficiency of a cross-linking agent which is formulated for cross-linking a cross-linkable polyolefin is lowered due to an amount of the antioxidant which is increasing formulated and rather a cross-linking degree, a thermal deformation property and Hot value which are after cross-linking properties of the cross-linkable polyolefin are lowered and thus a cable insulating property is degraded as the thermal stability is decreased in non cross-linked portions in the long period. For example, as described in the Korean Patent No. 0413016 and the U.S. Pat. No. 6,869,995, an efficient cross-linking property can not be obtained as the proper cross-linking degree can not be obtained in the case of increasing the formulating amount of 4,4′-thiobis(2-t-butyl-5-methylphenol) more than 0.4%. Because polyethylene glycol (hereinafter, referred to as PEG) is weak to heat, it is important to be thermally stable in the case of using PEG. More studies are therefore necessary to apply PEG. In this aspect, the method of increasing formulating antioxidant used in conventional power cables proposed in the aforementioned prior patent has advantages of increasing thermal-oxidative stability as well as increasing scorch resistance when cross-linking by increasing formulation of antioxidant, however has a disadvantage that the proper cross-linking degree can not be obtained in a process of cross-linking cross-linkable polyethylene. The thermal-oxidative stability is rather lowered in the viewpoint of long period, because non cross-linked portions are relatively increased after the cross-linking in the case that the cross-linking degree is low.

### DISCLOSURE

### Technical Problem

An object of the present invention, to solve the above problem, is to provide a tree resistant, cross-linkable polyolefin composition for insulation of a high voltage power cable, capable of improving electric properties of an insulator of the high voltage power cable and a long-life stability of an underground distribution cable as having a more superior resistance to water tree deterioration caused by moisture, superior thermal-oxidative stability and scorch stability as well as a proper cross-linking degree after cross-linking.

### Technical Solution

The present invention relates to a tree resistant, cross-linkable polyolefin resin composition for insulation capable of improving electric properties of an insulator of the high voltage power cable and thus improving a long-life stability of an underground distribution cable as having a more superior resistance to water tree deterioration caused by moisture, superior thermal-oxidative stability, superior scorch resistance when extruding as well as obtaining a proper cross-linking degree when cross-linking. In more detail, the tree resistant, cross-linkable polyolefin composition according to the present invention having superior water tree resistant property, thermal-oxidative stability and cross-linking property, which includes i) 100 parts by weight of polyethylene; and based on 100 parts by weight of the polyethylene, ii) 1 to 4 parts by weight of chemical cross-linking agent; iii) 0.3 to 0.8 parts by weight of antioxidant; and iv) 0.3 to 1.0 parts by weight of polyethylene glycol having a molecular weight in the range of 5000 to 50000. In addition, the tree resistant, cross-linkable polyolefin composition may further include 0.1 to 1.0 parts by weight of 2,4-diphenyl-4-methyl-1-pentene as a cross-linking promoting agent which acts to increase the cross-linking efficiency of the cross-linkable polyolefin.

The polyethylene used in the present invention may be a homopolymer made by polymerization under high temperature and high pressure by free radical initiated reaction in a tubular or autoclave reactor, a copolymer made by copolymerization of ethylene and comonomer by using a Ziegler-Natta catalyst or a metallocene catalyst under low temperature and low pressure or copolymer of at least one alpha olefin selected from the group consisting of 1-butene, 1-hexene, 4-methyl-1-pentene and 1-octene.

A polymerizing of homopolymer under high pressure is described in Introduction to Polymer Chemistry (Wiley and Sons, New York, 1982, pages 149 to 153) and a polymerizing of copolymer by using the Ziegler-Natta catalyst or the metallocene catalyst described in U.S. Pat. Nos. 4,101,445, 4,302,565, 4,918,038, 5,272,236, 5,290,745 and 5,317,037.

In addition, The polyethylene can have a density in the range of 0.800 to 0.935 g/cm³, a melt index in the range of about 0.1 to 30 g/10 min (measured at a temperature of 190° C. in load of 2.16Kg), Mw/Mn in the range of 2 to 15 and a weight average molecular weight in the range of 50,000 to 300,000. If the density is lower than this range, the polyethylene is inadequate for the insulating material since its melting point is lowered and thus thermal resistance is reduced; if the density exceeds the range, to the contrary, early decomposition of the chemical cross-linking agent may be caused when extruding the cross-linking composition since the melting point is increased. In addition, if the melt index and the Mw/Mn are lower than each range, an extruding processability of the cross-linking composition is degraded and, if exceeding each range, to the contrary, a superior mechanical property can not be obtained after the cross-linking insulation to the power cable of the composition according to the present invention. If the weight average molecular weight is lower than the above range, the superior mechanical property can not be obtained after the cross-linking insulation to the power cable of the composition according to the present invention; if the weight average molecular weight exceeds the range, to the contrary, the extruding processability of the cross-linking composition is degraded.

The cross-linking agent used in the present invention is an additive which should be used to increase physical property and thermal resistant stability for the purpose of insulation under high pressure by cross-linking an insulator in a vulcanizing tube when insulating high voltage power cable for an outdoor use, and may be used alone or together with a cross-linking promoting agent. The most widely used cross-linking agent is an organic peroxide such as dicumyl peroxide (DCP), ditertiarybutyl peroxide (DTBP) or ditertiarybutyl peracetate (TBPA) or the like, and the proper amount of usage is 1 to 4 parts by weight based on 100 parts by weight of the polyethylene of the overall cross-linkable polyolefin resin composition. If the amount is lower than the above range, it is impossible to obtain an effective cross-linking efficiency of the composition; if exceeds the range, to the contrary, the extruding processability may be rather degraded by an occurrence of a slipping phenomenon due to a cross-linking agent when extruding the cross-linking polyethylene and a trouble of the extruding processability may occur due to a migration trouble of the cross-linking agent or an electric insulating property of the power cable may be reduced after the cross-linking in a long period of preservation.

Meanwhile, an antioxidant is a mixture including 4,4′-thiobis(2-t-butyl-5-methylphenol) and at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate, and thus a cross-linkable polyolefin composition having high cross-linking degree as well as superior thermal-oxidative stability and scorch resistance can be obtained.

In other words, the antioxidant used in the present invention is a mixture including polyethylene, and based on 100 parts by weight of the polyethylene, 0.1 to 0.23 parts by weight of 4,4′-thiobis(2-tert-butyl-5-methylphenol) and 0.1 to 0.4 parts by weight of at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate; preferably 0.15 to 0.22 parts by weight of 4,4′-thiobis(2-tert-butyl-5-methylphenol) and 0.1 to 0.4 parts by weight of at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate; and proper amount of usage is 0.3 to 0.8 parts by weight based on 100 parts by weight of the polyethylene. In a combination of these antioxidants, 4,4′-thiobis(2-tert-butyl-5-methylphenol) has a disadvantage of separating cross-link as it acts to eliminate a radical which is generated by the cross-linking agent for cross-linking of the polyethylene since it has a superior antioxidation force in a cross-linked product if used more than the proper amount. In order to overcome the disadvantage and at the same time take the superior antioxidation force which is the advantage of 4,4′-thiobis(2-tert-butyl-5-methylphenol), 4,4′-thiobis(2-tert-butyl-5-methylephenol) is mixed with at least one antioxidant selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate. The tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate should be used in high amount for increasing thermal stability when they are used alone, respectively, and a trouble occurs as an extruding processability of the composition is influenced if used in the high amount.

In the present invention, therefore, at least one antioxidant selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate is mixed with 4,4′-thiobis(2-tert-butyl-5-methylphenol) and used in the above mentioned range of formulating amount and thus it is possible to obtain proper thermal-oxidative stability and high cross-linking efficiency and scorch resistance.

To sum up the above description, if the amount is lower than the above range, it is possible to obtain the high cross-linking degree of the cross-linkable polyethylene whereas thermal-oxidative stability and resistance to scorch phenomenon in which the cross-linking agent is early decomposed when extruding the composition may be reduced. On the contrary, if the amount exceeds the above range, the cross-linking degree is lowered as the cross-linking efficiency of the cross-linking agent is lowered and consequently the after cross-linking property of the cross-linking agent is degraded and a cable insulating property is degraded as the thermal-oxidative stability is decreased in non cross-linked portions in the long period.

2,4-diphenyl-4-methyl-1-pentene used in the present invention is a cross-linking promoting agent which acts to increase the cross-linking efficiency when cross-linking of the cross-linkable polyolefin and also acts to increase a scorch resistance.

Generally, an antioxidant is used for thermal-oxidative stability of the cross-linkable polyolefin. A main function of the antioxidant is to eliminate a radical which generates thermal-oxidation of a polymer resin. However, in order to cross-link a polymer, radical is primarily generated in the polymer by the cross-linking agent and the portions where the radical is generated are connected to become a cross-link. Since the cross-linking agent and the antioxidant have functions opposite to each other, they should be used in proper amounts so that the cross-linking property finally becomes superior. In the case of using the antioxidant more than the proper amount in order to increase the thermal stability of the cross-linkable polyolefin, the thermal-oxidative stability is rather degraded as the antioxidant acts to reduce a cross-linking efficiency of the cross-linking agent and thus the cross-linking degree of the cross-linkable polyolefin is lowered. In addition, in the case of using high amount of the cross-linking agent and formulating the antioxidant lower than the proper amount, partial cross-linked portions such as a scorch are formed when extruding by early thermal decomposition of the excessive amount of the cross-linking agent, whereby finally lead to a decrease in dielectric strength which is an electric property of the power cable insulator.

Conventionally used cross-linking promoting agents have a function of increasing decomposition speed of the cross-linking agent as well as the cross-linking efficiency. The cross-linking promoting agent, however, has superior cross-linking efficiency since it promotes decomposition speed of the cross-linking agent whereas has a disadvantage of lowering of the scorch resistance as occurrence of early cross-linking. The 2,4-diphenyl-4-methyl-1-pentene (DMP), however, has advantages of increasing cross-linking efficiency when cross-linking thereby increasing density of net-shaped structure of the cross-linkable polyethylene having a cross-linkable structure and increasing the scorch resistance when used in proper amount.

The 2,4-diphenyl-4-methyl-1-pentene, which is a cross-linking promoting agent used in the present invention, is therefore used to solve the above problem and acts to increase thermal-oxidative stability of the cross-linkable polyolefin as it increases antioxidant formulation and thus raise the thermal-oxidative stability, and to decrease the scorch phenomenon which is an early cross-linking phenomenon and resist a function of decreasing the cross-linking efficiency of the cross-linking agent.

An amount of the 2,4-diphenyl-4-methyl-1-pentene used in the present invention is 0.1 to 1.0 parts by weight based on 100 parts by weight of polyolefin; if the amount is lower than 0.1 parts by weight, cross-linking promoting effect is low, and if the amount exceeds 1.0 parts by weight, the cross-linking efficiency is rather lowered to lead to decrease in a cross-linking degree after the cross-linking.

Preferably, a mixing ratio of the cross-linking promoting agent and the antioxidant is 1:0.5 to 1:1.5 and a mixing ratio of the cross-linking agent such as dicumyl peroxide (DCP), ditertiarybutyl peroxide (DTBP) or ditertiarybutyl peracetate (TBPA) or the like is 12:1 to 4:1.

In addition, polyethylene glycol used in the present invention for resisting water tree is the polyethylene glycol having a molecular weight in the range of 5,000 to 50,000 and is a polar polymer made by copolymerization of ethylene and ethylene glycol. The polyethylene glycol has a molecular formula of HO(C₂H₄O)ₙH and n of 100 to 1000; this means the molecular weight is in the range of 5,000 to 50,000. If the molecular weight is lower than the above range, a trouble may occur since the molecular weight is low and thus the thermal stability is not good; if the molecular weight exceeds the range, to the contrary, compatibility with nonpolar polyethylene is not good and thus uniform dispersion may not be obtained when kneading

An usage amount of the polyethylene glycol is 0.3 to 1 parts by weight per based on 100 parts by weight of polyolefin; if the amount is lower than 0.3 parts by weight, effective water tree resistance can not be obtained, and if the amount exceeds 1 parts by weight, a melting point of the polyethylene glycol is low, which causes a non-uniformity in an extrusion by the polyethylene glycol when extruding a composition added with the polyethylene and thus result in a non-uniformity in an insulation thickness when insulating a cable, and a long period thermal stability may be lowered by thermally unstable polyethylene glycol.

A method for measuring a water tree resistance property of polymer insulating material such as polyethylene is described well in U.S. Pat. No. 4,144,202. The method for measuring a water tree resistance property proposed in the above mentioned patent is a method for measuring and evaluating relatively the water tree resistance property of polyethylene with the water tree resistance property in relation to polyethylene without the water tree resistance property. The term used for such relative water tree resistance property is “water tree growth rate” (WTGR). The method for measuring a water tree resistance property of polymer insulating material proposed in the above mentioned patent was more specified to be established as an official test method ASTM D 6097 (see FIG. 1) and is currently employed as a standard test method in various countries. In the present invention, a test specimen for evaluating the water tree resistance property was prepared according to ASTM D 6097 in order to evaluation for the water tree resistance property of the cross-linkable polyethylene. The test to the water tree resistance property was performed under ASTM D 6097 at AC 4.5 kV (1.6 kV/mm) and 1 kHz; a concentration of salt water is in condition more severe than 0.01M which is the standard test salt water concentration (increasing concentration of the salt water to 0.5M); test period was fixed to 30 days in every tests.

Mechanical property at room temperature of the cross-linkable polyolefin after the cross-linking was measured according to ASTM D 638 after preparing test specimen by former at a temperature of 180° C. and for 20 minutes of cross-linking time. In addition, Hot value after the cross-linking was measured based on ICEA T-28-562 (Hot value is a value, which is expressed as %, of an extended length for the original length when pulling the specimen with a 20N/cm² of load in an oven which is maintained at 200° C. and the higher cross-linking degree is, the higher the Hot value), and a tensile property after thermal aging was measured in accordance with ASTM D 638 test method after thermally oxidizing the specimen for 3 weeks (21 days) in an air circulating oven which is maintained at 150° C. In addition, the cross-linking degree of the test specimen after the cross-linking was measured in accordance with ASTM D 2765A. Measurement for MH which is a cross-linking behavior of the cross-linkable polyolefin (a maximum torque indicating degree of cross-linking when cross-linking) and scorch time which notifies an information for early cross-linking when cable insulation of the cross-linkable polyolefin was analyzed at 180° C. using MDR(Moving Disc Rheometer) device.

### DESCRIPTION OF DRAWINGS

FIG. 1 is a diagram schematically illustrating concept of ASTM D 6097 test method which is an official method for measuring a water tree resistance property of polymer insulating material.

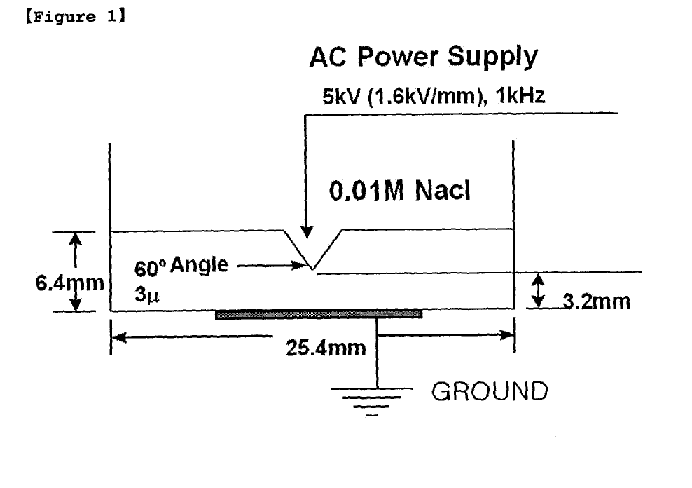

### BEST MODE

Hereinafter, the embodiments of the present invention will be described in detail. However, it will be appreciated that those skilled in the art, on consideration of this disclosure, may make modifications and improvements within the spirit and scope of the present invention.

### Example 1

Polyethylene homopolymer, which is a base resin, having a density of 0.920 g/cm³ and a melt index of 2 g/10 min, and based on 100 parts by weight of the polyethylene homopolymer, 0.15 parts by weight of 4,4′-thiobis(3-methyl-6-tert-butylphenol) and 0.15 parts by weight of 4,6-bis(octylthiobutyl)-o-cresol which are antioxidants, and 0.7 parts by weight of polyethylene glycol for resisting water tree, having a molecular weight of 20,000 were put in a Banbury mixer which is maintained at 130° C. and kneaded for 10 minutes, after then the kneaded mixture was extruded through a single screw continuous extruder which is maintained at 180° C. to be formed in a pallet shape. The pallet prepared as above described was put together with 2 parts by weight of dicumyl peroxide which is a cross-linking agent in a Henschel mixer which is maintained at 80° C. and the Henschel mixer was kept rotated at 60 rpm for 30 minutes so that the base resin is impregnate with the cross-linking agent, and thus finally a cross-linkable polyolefin composition was prepared. After then, the composition was tested for water tree property, mechanical properties at a room temperature and after thermal aging, a cross-linking degree, Hot and cross-linking behavior (MH and scorch time) in accordance with the above mentioned test and evaluating method, and the test results are shown in Table 1.

### Example 2

The same as Example 1, except that a cross-linkable polyolefin composition was prepared using 0.2 parts by weight of 4,4′-thiobis(3-methyl-6-tert-butylphenol) and 0.1 parts by weight of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 3

The same as Example 1, except that a cross-linkable polyolefin composition was prepared using 0.2 parts by weight of 4,4′-thiobis(3-methyl-6-tert-butylphenol) and 0.2 parts by weight of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 4

The same as Example 1, except that a cross-linkable polyolefin composition was prepared using 0.2 parts by weight of 4,4′-thiobis(3-methyl-6-tert-butylphenol), 0.1 parts by weight of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 5

The same as Example 1, except that a cross-linkable polyolefin composition was prepared using 0.2 parts by weight of 4,4′-thiobis(3-methyl-6-tert-butylphenol), 0.1 parts by weight of 4,6-bis(octylthiobutyl)-o-cresol and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 6

The same as Example 1, except that a cross-linkable polyolefin composition was prepared using 0.2 parts by weight of 4,4′-thiobis(3-methyl-6-tert-butylphenol), 0.2 parts by weight of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 7

The same as Example 1, except that a cross-linkable polyolefin composition was prepared using 0.2 parts by weight of 4,4′-thiobis(3-methyl-6-tert-butylphenol), 0.2 parts by weight of 4,6-bis(octylthiobutyl)-o-cresol, and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 8

The same as Example 1, except that a cross-linkable polyolefin composition was prepared using 0.2 parts by weight of 4,4′-thiobis(3-methyl-6-tert-butylphenol) and 0.1 parts by weight of tetrakis[methylene(3,5-di-tert-butyl-4-hydroxy-hydrocinnamate)]methane instead of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 9

The same as Example 1, except that a cross-linkable polyolefin composition was prepared using 0.2 parts by weight of 4,4′-thiobis(3-methyl-6-tert-butylphenol) and 0.3 parts by weight of tetrakis[methylene(3,5-di-tert-butyl-4-hydroxy-hydrocinnamate)]methane instead of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 10

The same as Example 1, except that a cross-linkable polyolefin composition was prepared using 0.2 parts by weight of 4,4′-thiobis(3-methyl-6-tert-butylphenol), 0.1 parts by weight of tetrakis[methylene(3,5-di-tert-butyl-4-hydroxy-hydrocinnamate)]methane instead of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 11

The same as Example 1, except that a cross-linkable polyolefin composition was prepared using 0.2 parts by weight of 4,4′-thiobis(3-methyl-6-tert-butylphenol), 0.1 parts by weight of tetrakis[methylene(3,5-di-tert-butyl-4-hydroxy-hydrocinnamate)]methane instead of 4,6-bis(octylthiobutyl)-o-cresol and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 12

The same as Example 1, except that a cross-linkable polyolefin composition was prepared using 0.2 parts by weight of 4,4′-thiobis(3-methyl-6-tert-butylphenol), 0.3 parts by weight of tetrakis[methylene(3,5-di-tert-butyl-4-hydroxy-hydrocinnamate)]methane instead of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 13

The same as Example 1, except that a cross-linkable polyolefin composition was prepared using 0.2 parts by weight of 4,4′-thiobis(3-methyl-6-tert-butylphenol), 0.3 parts by weight of tetrakis[methylene(3,5-di-tert-butyl-4-hydroxy-hydrocinnamate)]methane instead of 4,6-bis(octylthiobutyl)-o-cresol and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 14

The same as Example 1, except that a cross-linkable polyolefin composition was prepared using 0.15 parts by weight of 2,2′-thiobis[ethyl-3-(3,5-di-tert-butyl-4-hydrophenyl)]-propionate instead of 4,6-bis(octylthiobutyl)-o-cresol which is an antioxidant. After then, tests were made for water tree property, mechanical properties at a room temperature and after thermal aging, a cross-linking degree, Hot and cross-linking behavior (MH and scorch time) and the test results are shown in Table 1.

### Example 15

The same as Example 1, except that a cross-linkable polyolefin composition was prepared using 0.2 parts by weight of 4,4′-thiobis(3-methyl-6-tert-butylphenol) and 0.1 parts by weight of 2,2′-thiobis[ethyl-3-(3,5-di-tert-butyl-4-hydrophenyl)]-propionate instead of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 16

The same as Example 1, except that a cross-linkable polyolefin composition was prepared using 0.2 parts by weight of 4,4′-thiobis(3-methyl-6-tert-butylphenol) and 0.3 parts by weight of 2,2′-thiobis[ethyl-3-(3,5-di-tert-butyl-4-hydrophenyl)]-propionate instead of 4,6-bis(octylthiobutyl)-o-cresol which are antioxidants. After then, tests were made for water tree property, mechanical properties at a room temperature and after thermal aging, a cross-linking degree, Hot and cross-linking behavior (MH and scorch time) and the test results are shown in Table 1.

### Example 17

The same as Example 1, except that a cross-linkable polyolefin composition was prepared using 0.2 parts by weight of 4,4′-thiobis(3-methyl-6-tert-butylphenol), 0.1 parts by weight of 2,2′-thiobis[ethyl-3-(3,5-di-tert-butyl-4-hydrophenyl)]-propionate instead of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 18

The same as Example 1, except that a cross-linkable polyolefin composition was prepared using 0.2 parts by weight of 4,4′-thiobis(3-methyl-6-tert-butylphenol), 0.1 parts by weight of 2,2′-thiobis[ethyl-3-(3,5-di-tert-butyl-4-hydrophenyl)]-propionate instead of 4,6-bis(octylthiobutyl)-o-cresol and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 19

The same as Example 1, except that a cross-linkable polyolefin composition was prepared using 0.2 parts by weight of 4,4′-thiobis(3-methyl-6-tert-butylphenol), 0.3 parts by weight of 2,2′-thiobis[ethyl-3-(3,5-di-tert-butyl-4-hydrophenyl)]-propionate instead of 4,6-bis(octylthiobutyl)-o-cresol and 0.15 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Example 20

The same as Example 1, except that a cross-linkable polyolefin composition was prepared using 0.2 parts by weight of 4,4′-thiobis(3-methyl-6-tert-butylphenol), 0.3 parts by weight of 2,2′-thiobis[ethyl-3-(3,5-di-tert-butyl-4-hydrophenyl)]-propionate instead of 4,6-bis(octylthiobutyl)-o-cresol and 0.3 parts by weight of 2,4-diphenyl-4-methyl-1-pentene which are antioxidants. After then, tests were made for water tree property, mechanical properties at a room temperature and after thermal aging, a cross-linking degree, Hot and cross-linking behavior (MH and scorch time) and the test results are shown in Table 1.

### Comparative Example 1

Preparation of a Cross-Linkable Polyolefin Composition is the same as Example 1, except for using 0.2 parts by weight of 4,4′-thiobis(3-methyl-6-tert-butylphenol) which is an antioxidant, no 4,6-bis(octylthiobutyl)-o-cresol and no polyethylene glycol. After then, tests were made for water tree property, mechanical properties at a room temperature and after thermal aging, a cross-linking degree, Hot and cross-linking behavior (MH and scorch time) and the test results are shown in Table 1.

### Comparative Example 2

Preparation of a Cross-Linkable Polyolefin Composition is the same as Example 1, except for using 0.2 parts by weight of 4,4′-thiobis(3-methyl-6-tert-butylphenol) which is an antioxidant, 0.3 parts by weight of polyethylene glycol and no 4,6-bis(octylthiobutyl)-o-cresol. After then, tests were made for water tree property, mechanical properties at a room temperature and after thermal aging, a cross-linking degree, Hot and cross-linking behavior (MH and scorch time) and the test results are shown in Table 1.

### Comparative Example 3

Preparation of a Cross-Linkable Polyolefin Composition is the same as Example 1, except for using 0.2 parts by weight of 4,4′-thiobis(3-methyl-6-tert-butylphenol) which is an antioxidant and no 4,6-bis(octylthiobutyl)-o-cresol. After then, tests were made for water tree property, mechanical properties at a room temperature and after thermal aging, a cross-linking degree, Hot and cross-linking behavior (MH and scorch time) and the test results are shown in Table 1.

### Comparative Example 4

Preparation of a Cross-Linkable Polyolefin Composition is the same as Example 1, except for using 0.2 parts by weight of 4,4′-thiobis(3-methyl-6-tert-butylphenol) which is an antioxidant, 1.0 parts by weight of polyethylene glycol and no 4,6-bis(octylthiobutyl)-o-cresol. After then, tests were made for water tree property, mechanical properties at a room temperature and after thermal aging, a cross-linking degree, Hot and cross-linking behavior (MH and scorch time) and the test results are shown in Table 1.

### Comparative Example 5

Preparation of a Cross-Linkable Polyolefin Composition is the same as Example 1, except for using 0.3 parts by weight of 4,4′-thiobis(3-methyl-6-tert-butylphenol) which is an antioxidant and no 4,6-bis(octylthiobutyl)-o-cresol. After then, tests were made for water tree property, mechanical properties at a room temperature and after thermal aging, a cross-linking degree, Hot and cross-linking behavior (MH and scorch time) and the test results are shown in Table 1.

### Comparative Example 6

Preparation of a Cross-Linkable Polyolefin Composition is the same as Example 1, except for using 0.5 parts by weight of 4,4′-thiobis(3-methyl-6-tert-butylphenol) which is an antioxidant and no 4,6-bis(octylthiobutyl)-o-cresol. After then, tests were made for water tree property, mechanical properties at a room temperature and after thermal aging, a cross-linking degree, Hot and cross-linking behavior (MH and scorch time) and the test results are shown in Table 1.

TABLE 1

| | | Example | Example | Example | Example | Example | Example | Example |
|---|---|---|---|---|---|---|---|---|
| | | 1 | 2 | 3 | 4 | 5 | 6 | 7 |
| *¹LDPE | | 100 | 100 | 100 | 100 | 100 | 100 | 100 |
| *²DCP | | 2.0 | 2.0 | 2.0 | 2.0 | 2.0 | 2.0 | 2.0 |
| *³Antioxidant | | 0.15 | 0.2 | 0.2 | 0.2 | 0.2 | 0.2 | 0.2 |
| *⁴Antioxidant | | 0.15 | 0.1 | 0.2 | 0.1 | 0.1 | 0.2 | 0.2 |
| *⁵Antioxidant | | — | — | — | — | — | — | — |
| *⁶Antioxidant | | — | — | — | — | — | — | — |
| *⁷DMP | | — | — | — | 0.15 | 0.3 | 0.15 | 0.3 |
| *⁸PEG | | 0.7 | 0.7 | 0.7 | 0.7 | 0.7 | 0.7 | 0.7 |
| *⁹The length | | 295 | 290 | 300 | 280 | 315 | 290 | 300 |
| of water | | | | | | | | |
| tree (μm) | | | | | | | | |
| *¹⁰RWTG | | 10.8 | 10.8 | 10.7 | 11.4 | 10.1 | 10.8 | 10.7 |
| Tensile | Tensile | 205 | 200 | 210 | 205 | 210 | 200 | 215 |
| strength | strength | | | | | | | |
| at a | (kg/cm²) | | | | | | | |
| room | Elonga- | 510 | 500 | 510 | 510 | 510 | 510 | 510 |
| temper- | tion | | | | | | | |
| ature | ratio | | | | | | | |
| | (%) | | | | | | | |
| *¹¹Ten- | Tensile | More | More | More | More | More | More | More |
| sile | strength | than | than | than | than | than | than | than |
| strength | (kg/cm²) | 75 | 75 | 75 | 75 | 75 | 75 | 75 |
| after | Elonga- | More | More | More | More | More | More | More |
| thermal | tion | than | than | than | than | than | than | than |
| aging | ratio | 75 | 75 | 75 | 75 | 75 | 75 | 75 |
| | (%) | | | | | | | |

| | | | | | | | |
|---|---|---|---|---|---|---|---|
| Cross- | 84 | 81.5 | 80.2 | 81.8 | 82.7 | 80.9 | 81.6 |
| linking | | | | | | | |
| degree (%) | | | | | | | |
| Hot (%) | 65 | 70 | 75 | 62 | 57 | 72 | 64 |
| *¹²Scorch | 78 | 80 | 82 | 81 | 83 | 83 | 85 |
| time | | | | | | | |
| (Minutes) | | | | | | | |
| *¹³MH | 5.3 | 5.0 | 4.5 | 5.16 | 5.3 | 4.71 | 4.9 |

| | | Example | Example | Example | Example | Example | Example |
|---|---|---|---|---|---|---|---|
| | | 8 | 9 | 10 | 11 | 12 | 13 |
| *¹LDPE | | 100 | 100 | 100 | 100 | 100 | 100 |
| *²DCP | | 2.0 | 2.0 | 2.0 | 2.0 | 2.0 | 2.0 |
| *³Antioxidant | | 0.2 | 0.2 | 0.2 | 0.2 | 0.2 | 0.2 |
| *⁴Antioxidant | | — | — | — | — | — | — |
| *⁵Antioxidant | | 0.1 | 0.3 | 0.1 | 0.1 | 0.3 | 0.3 |
| *⁶Antioxidant | | — | — | — | — | — | — |
| *⁷DMP | | — | — | 0.15 | 0.3 | 0.15 | 0.3 |
| *⁸PEG | | 0.7 | 0.7 | 0.7 | 0.7 | 0.7 | 0.7 |
| *⁹The length | | 290 | 300 | 280 | 315 | 295 | 300 |
| of water tree | | | | | | | |
| (μm) | | | | | | | |
| *¹⁰RWTG | | 10.8 | 10.7 | 11.4 | 10.1 | 10.8 | 10.7 |
| Tensile | Tensile | 200 | 210 | 200 | 200 | 205 | 210 |
| strength | strength | | | | | | |
| at a | (kg/cm²) | | | | | | |
| room | Elonga- | 510 | 510 | 510 | 510 | 510 | 510 |
| temper- | tion | | | | | | |
| ature | ratio | | | | | | |
| | (%) | | | | | | |
| *¹¹Ten- | Tensile | More | More | More | More | More | More |
| sile | strength | than | than | than | than | than | than |
| strength | (kg/cm²) | 75 | 75 | 75 | 75 | 75 | 75 |
| after | Elonga- | More | More | More | More | More | More |
| thermal | tion | than | than | than | than | than | than |
| aging | ratio | 75 | 75 | 75 | 75 | 75 | 75 |
| | (%) | | | | | | |

| | | | | | | |
|---|---|---|---|---|---|---|
| Cross-linking | 84 | 81.4 | 84 | 85 | 81.7 | 82.6 |
| degree (%) | | | | | | |
| Hot (%) | 50 | 60 | 47 | 46 | 54 | 51 |
| *¹²Scorch time | 75 | 80 | 77 | 78 | 81 | 82 |
| (Minutes) | | | | | | |
| *¹³MH | 5.79 | 5.42 | 5.93 | 6.14 | 5.55 | 5.78 |

| | | Example | Example | Example | Example | Example | Example | Example |
|---|---|---|---|---|---|---|---|---|
| | | 14 | 15 | 16 | 17 | 18 | 19 | 20 |
| *¹LDPE | | 100 | 100 | 100 | 100 | 100 | 100 | 100 |
| *²DCP | | 2.0 | 2.0 | 2.0 | 2.0 | 2.0 | 2.0 | 2.0 |
| *³Antioxidant | | 0.15 | 0.2 | 0.2 | 0.2 | 0.2 | 0.2 | 0.2 |
| *⁴Antioxidant | | — | — | — | — | — | — | — |
| *⁵Antioxidant | | — | — | — | — | — | — | — |
| *⁶Antioxidant | | 0.15 | 0.1 | 0.3 | 0.1 | 0.1 | 0.3 | 0.3 |
| *⁷DMP | | — | — | — | 0.15 | 0.3 | 0.15 | 0.3 |
| *⁸PEG | | 0.7 | 0.7 | 0.7 | 0.7 | 0.7 | 0.7 | 0.7 |
| *⁹The length | | 295 | 290 | 300 | 310 | 315 | 310 | 305 |
| of water | | | | | | | | |
| tree (μm) | | | | | | | | |
| *¹⁰RWTG | | 10.8 | 10.8 | 10.6 | 10.3 | 10.1 | 10.3 | 10.7 |
| Tensile | Tensile | 205 | 200 | 200 | 200 | 200 | 200 | 200 |
| strength | strength | | | | | | | |
| at a | (kg/cm²) | | | | | | | |
| room | Elonga- | 500 | 510 | 510 | 510 | 510 | 510 | 510 |
| temper- | tion | | | | | | | |
| ature | ratio | | | | | | | |
| | (%) | | | | | | | |
| *¹¹Ten- | Tensile | More | More | More | More | More | More | More |
| sile | strength | than | than | than | than | than | than | than |
| strength | (kg/cm²) | 75 | 75 | 75 | 75 | 75 | 75 | 75 |
| after | Elonga- | More | More | More | More | More | More | More |
| thermal | tion | than | than | than | than | than | than | than |
| aging | ratio | 75 | 75 | 75 | 75 | 75 | 75 | 75 |
| | (%) | | | | | | | |

| | | | | | | | |
|---|---|---|---|---|---|---|---|
| Cross- | 83 | 81.5 | 80 | 82.3 | 83.5 | 80.6 | 81.3 |
| linking | | | | | | | |
| degree (%) | | | | | | | |
| Hot (%) | 55 | 63 | 70 | 54 | 50 | 57 | 61 |
| *¹²Scorch | 76 | 76 | 78 | 78 | 80 | 83 | 86 |
| time | | | | | | | |
| (Minutes) | | | | | | | |
| *¹³MH | 5.78 | 5.55 | 4.93 | 5.72 | 5.85 | 5.2 | 5.4 |

| | | Compar- | Compar- | Compar- | Compar- | Compar- | Compar- |
|---|---|---|---|---|---|---|---|
| | | ative | ative | ative | ative | ative | ative |
| | | Example | Example | Example | Example | Example | Example |
| | | 1 | 2 | 3 | 4 | 5 | 6 |
| *¹LDPE | | 100 | 100 | 100 | 100 | 100 | 100 |
| *²DCP | | 2.0 | 2.0 | 2.0 | 2.0 | 2.0 | 2.0 |
| *³Antioxidant | | 0.2 | 0.2 | 0.2 | 0.2 | 0.3 | 0.5 |
| *⁴Antioxidant | | — | — | — | — | — | — |
| *⁵Antioxidant | | — | — | — | — | — | — |
| *⁶Antioxidant | | — | — | — | — | — | — |
| *⁷DMP | | — | — | — | 0.15 | 0.3 | 0.15 |
| *⁸PEG | | 0 | 0.3 | 0.7 | 1.0 | 0.7 | 0.7 |
| *⁹The length | | 950 | 570 | 310 | 220 | 300 | 290 |
| of water tree | | | | | | | |
| (μm) | | | | | | | |
| *¹⁰RWTG | | 3.4 | 5.6 | 10.3 | 14.5 | 10.7 | 11 |
| Tensile | Tensile | 205 | 205 | 210 | 210 | 200 | 205 |
| strength | strength | | | | | | |
| at a | (kg/cm²) | | | | | | |
| room | Elonga- | 510 | 500 | 510 | 510 | 510 | 510 |
| temper- | tion | | | | | | |
| ature | ratio | | | | | | |
| | (%) | | | | | | |
| *¹¹Ten- | Tensile | More | More | More | Less | More | More |
| sile | strength | than | than | than | than | than | than |
| strength | (kg/cm²) | 75 | 75 | 75 | 75 | 75 | 75 |
| after | Elonga- | More | More | Less | Less | More | More |
| thermal | tion | than | than | than | than | than | than |
| aging | ratio | 75 | 75 | 75 | 75 | 75 | 75 |
| | (%) | | | | | | |

| | | | | | | |
|---|---|---|---|---|---|---|
| Cross-linking | 85 | 84.7 | 84 | 84 | 80 | 73 |
| degree (%) | | | | | | |
| Hot (%) | 55 | 56 | 55 | 57 | 75 | 125 |
| *¹²Scorch time | 74 | 74 | 74 | 74 | 80 | 100 |
| (Minutes) | | | | | | |
| *¹³MH | 5.8 | 5.82 | 5.76 | 5.72 | 4.8 | 3.9 |

*¹Low Density Polyethylene: Product of Hanhwa Chemical Corporation
*²Cross-linking agent: Dicumyl peroxide
*³Antioxidant: 4,4′-thiobis(3-methyl-6-tert-butylphenol)
*⁴Antioxidant: 4,6-bis(octylthiobutyl)-o-cresol
*⁵Antioxidant: tetrakis[methylene(3,5-di-tert-butyl-4-hydroxy-hydrocinnamate)]methane
*⁶Antioxidant: 2,2′-thiobis[ethyl-3-(3,5-di-tert-butyl-4-hydrophenyl)]-propionate
*⁷2,4-diphenyl-4-methyl-1-pentene
*⁸PEG: Polyethylene glycol having a molecular weight of 20,000
*⁹water tree test condition
applied voltage: 4.5 kV/mm
applied frequency: 1 kHz
concentration of salt water: 0.5M
test period: 30 days (720 hours)
*¹⁰Resistance to Water Tree Growth (RWTG): L/LWT
L: Length from an end of a conical defect on a specimen to the opposite surface of the specimen
LWT: The Length of the Water Tree
*¹¹Tensile property measured after thermal aging in an oven at 150° C. for 21 days
*¹² and ¹³Measured at 180° C. using MDR (Moving Disc Rheometer)

According to Table 1, in the cases of Comparative Examples 3, and 6 using 4,4′-thiobis(3-methyl-6-tert-butylphenol) alone which is an antioxidant in the state of containing all of polyethylene homopolymer, and based on 100 parts by weight of the polyethylene homopolymer, 2 parts by weight of dicumyl peroxide which is a chemical cross-linking agent and 0.7 parts by weight of PEG, it will be confirmed that if the usage amount of the antioxidant is increased, the thermal-oxidative stability and scorch resistance become better whereas the cross-linking degree is markedly lowered from 84% to 73%. However, Examples 1 to 3, 8, 9 and 14 to 16 using an antioxidant according to the present invention or a mixture including 4,4′-thiobis(2-tert-butyl-5-methylphenol) and at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate exhibited high cross-linking degree of more than 80% as well as a superior thermal-oxidative stability even though the usage amount of the antioxidant is increased. Meanwhile, in the cross-linkable polyethylene, though scorch resistance can be obtained by increasing the usage amount of the antioxidant, the increased usage of the antioxidant results in a problem of decrease in the cross-linking degree. To solve the above mentioned problem, the present invention further used 2,4-diphenyl-4-methyl-1-pentene which is a cross-linking promoting agent and thus could obtain proper thermal stability and high cross-linking degree at the same time. As can be appreciated from Examples 2, 4 and 6; Examples 3, 6 and 7; Examples 8, 10 and 11; Examples 9, 12 and 13; Examples 15, 17 and 18; Examples 16, 19 and 20, the cross-linking degree and scorch resistance were increased only by increasing formulating 2,4-diphenyl-4-methyl-1-pentene which is a cross-linking promoting agent without increasing formulation of an antioxidant.

In addition, in the case of Examples 2 and 3, lowering in the cross-linking degree from 81.5% to 80.2% as well as MH from 5.0 to 4.5 is exhibited as increasing formulation of an antioxidant, however in the case of Examples 6 and 7 in which DMP which is a cross-linking promoting agent is formulated after the increasing formulation of an antioxidant, it can be appreciated that the cross-linking degree was increased to 80.9% and 81.6% and MH value is also increased to 4.71 and 4.9. As such, it can be appreciated that lowering in the cross-linking degree as well as MH value is exhibited as described above in the cases of Examples 8 and 9; Example 15 and 16 in which the antioxidant is increasing formulated and increase in the cross-linking degree as well as MH value is exhibited in the cases of Examples 12 and 13; Example 19 and 20 in which DMP as the cross-linking promoting agent is increasing formulated.

From the results showed in the above Examples and Comparative Examples, it can be appreciated that using, as an antioxidant, a mixture including 4,4′-thiobis(2-tert-butyl-5-methylphenol) and at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate exhibited the superior thermal-oxidative stability and higher cross-linking degree than using 4,4′-thiobis(2-tert-butyl-5-methylphenol) alone, and the cross-linking degree and scorch resistance are increased only by increasing formulating 2,4-diphenyl-4-methyl-1-pentene (DMP) without increasing formulation of an antioxidant by further using as a cross-linking promoting agent 2,4-diphenyl-4-methyl-1-pentene.

### INDUSTRIAL APPLICABILITY

The tree resistant, cross-linkable polyolefin composition according to the present invention has superior resistance properties to occurrence and growth of water tree which causes deterioration due to moisture, superior thermal-oxidative stability and cross-linking property and thus is useful to be adapted to insulate underground distribution cables having superior long-life stability.

1. A tree resistant, cross-linkable polyolefin composition having superior water tree resistant property, thermal-oxidative stability and cross-linking property, comprising i) 100 parts by weight of polyethylene; and based on 100 parts by weight of the polyethylene, ii) 1 to 4 parts by weight of chemical cross-linking agent; iii) 0.3 to 0.8 parts by weight of antioxidant which is a mixture including 0.1 to 0.23 parts by weight of 4,4′-thiobis(2-tert-butyl-5-methylphenol) and 0.1 to 0.4 parts by weight of at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate; iv) 0.1 to 1.0 parts by weight of 2,4-diphenyl-4-methyl-1-pentene; and v) 0.3 to 1.0 parts by weight of polyethylene glycol having a molecular weight in the range of 5000 to 50000.

2. The tree resistant, cross-linkable polyolefin composition having superior water tree resistant property, thermal-oxidative stability and cross-linking property as set forth claim 1, wherein the polyethylene is a homopolymer made by polymerization under high temperature and high pressure by free radical initiated reaction in a tubular or autoclave reactor, a copolymer made by copolymerization of ethylene and comonomer by using a Ziegler-Natta catalyst or a metallocene catalyst under low temperature and low pressure or a copolymer of at least one alpha olefin.

3. The tree resistant, cross-linkable polyolefin composition having superior water tree resistant property, thermal-oxidative stability and cross-linking property as set forth claim 2, wherein the polyethylene has a density in the range of 0.800 to 0.935 g/cm³, a melt index in the range of about 0.1 to 30 g/10 min, Mw/Mn in the range of 2 to 15 and a weight average molecular weight in the range of 50,000 to 300,000.

4. The tree resistant, cross-linkable polyolefin composition having superior water tree resistant property, thermal-oxidative stability and cross-linking property as set forth claim 2, wherein the alpha olefin is at least one selected from the group consisting of 1-butene, 1-hexene, 4-methyl-1-pentene and 1-octene.

5. The tree resistant, cross-linkable polyolefin composition having superior water tree resistant property, thermal-oxidative stability and cross-linking property as set forth claim 1, wherein the chemical cross-linking agent is at least one organic peroxide selected from dicumyl peroxide, di-tert-butyl peroxide or di-tert-butyl peracetate.

6. The tree resistant, cross-linkable polyolefin composition having superior water tree resistant property, thermal-oxidative stability and cross-linking property as set forth claim 1, wherein a usage ratio of the 2,4-diphenyl-4-methyl-1-pentene and the antioxidant is 1:0.5 to 1:1.5.

7. A tree resistant, cross-linkable polyolefin composition having superior water tree resistant property, thermal-oxidative stability and cross-linking property, comprising i) 100 parts by weight of polyethylene; and based on 100 parts by weight of the polyethylene, ii) 1 to 4 parts by weight of chemical cross-linking agent; iii) 0.3 to 0.8 parts by weight of antioxidant which is a mixture including 0.1 to 0.23 parts by weight of 4,4′-thiobis(2-tert-butyl-5-methylphenol) and 0.1 to 0.4 parts by weight of at least one selected from the group consisting of tetrakis[methylene(3,5-di-tert-butyl-4-hydroxy-hydrocinnamate)]methane, 4,6-bis(octylthiobutyl)-o-cresol and 2,2′-thiobis[ethyl-3-(3,5-di-tert-butyl-4-hydrophenyl)]-propionate; and iv) 0.3 to 1.0 parts by weight of polyethylene glycol having a molecular weight in the range of 5000 to 50000.

8. The tree resistant, cross-linkable polyolefin composition having superior water tree resistant property, thermal-oxidative stability and cross-linking property as set forth claim 7, wherein the polyethylene is a homopolymer made by polymerization under high temperature and high pressure by free radical initiated reaction in a tubular or autoclave reactor, a copolymer made by copolymerization of ethylene and comonomer by using a Ziegler-Natta catalyst or a metallocene catalyst under low temperature and low pressure or a copolymer of at least one alpha olefin.

9. The tree resistant, cross-linkable polyolefin composition having superior water tree resistant property, thermal-oxidative stability and cross-linking property as set forth claim 8, wherein the polyethylene has a density in the range of 0.800 to 0.935 g/cm³, a melt index in the range of about 0.1 to 30 g/10 min, Mw/Mn in the range of 2 to 15 and a weight average molecular weight in the range of 50,000 to 300,000.

10. The tree resistant, cross-linkable polyolefin composition having superior water tree resistant property, thermal-oxidative stability and cross-linking property as set forth claim 8, wherein the alpha olefin is at least one selected from the group consisting of 1-butene, 1-hexene, 4-methyl-1-pentene and 1-octene.

11. The tree resistant, cross-linkable polyolefin composition having superior water tree resistant property, thermal-oxidative stability and cross-linking property as set forth claim 7, wherein the chemical cross-linking agent is at least one organic peroxide selected from dicumyl peroxide, di-tert-butyl peroxide or di-tert-butyl peracetate.
